(19) United States
(12) Patent Application Publication
(10) Pub. No.: US 2026/0006669 A1
(43) Pub. Date: Jan. 1, 2026

(54) METHOD AND APPARATUS FOR PATH SWITCH

(71) Applicant: LENOVO (BEIJING) LIMITED, Beijing (CN)

(72) Inventors: Lianhai WU, Beijing (CN); Mingzeng DAI, Shanghai (CN); Congchi ZHANG, Shanghai (CN); Le YAN, Shanghai (CN)

(21) Appl. No.: 18/879,584

(22) PCT Filed: Jun. 30, 2022
(86) PCT No.: PCT/CN2022/102764

§ 371 Date: Dec. 27, 2024

(51) Int. Cl. H04W 76/18; H04W 76/27

(52) U.S. Cl. CPC H04W 76/18; H04W 76/27

(57) ABSTRACT

Embodiments of the present disclosure relate to methods and apparatuses for path switch in a communication system. According to some embodiments of the disclosure, a UE may: receive, from a BS, an RRC reconfiguration message for a DAPS path switch from a source connection to a target connection, wherein the RRC reconfiguration message indicates an ID of a target relay node; and start a timer for path switch in response to receiving the RRC reconfiguration message.

### TECHNICAL FIELD

Embodiments of the present disclosure generally relate to communication technology, and more particularly to path switch in a communication system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In the above wireless communication systems, a user equipment (UE) may communicate with another UE via a data path supported by an operator's network, e.g., a cellular or a Wi-Fi network infrastructure. The data path supported by the operator's network may include a base station (BS) and multiple gateways.

Some wireless communication systems may support sidelink communications, in which devices (e.g., UEs) that are relatively close to each other may communicate with one another directly via a sidelink, rather than being linked through the BS. A relaying function based on a sidelink may be supported in a communication network. For example, a UE supporting sidelink communication may function as a relay node to extend the coverage of a BS. An out-of-coverage or in-coverage UE may communicate with a BS via a relay node (e.g., a relay UE). In the context of the present disclosure, a UE, which functions as a relay between another UE and a BS, may be referred to as a UE-to-network (U2N) relay.

There is a need for efficiently performing communication in a communication system supporting a U2N relay.

### SUMMARY

Some embodiments of the present disclosure provide a user equipment (UE). The UE may include: a transceiver; and a processor coupled to the transceiver. The processor may be configured to: receive, from a base station (BS), a radio resource control (RRC) reconfiguration message for a dual active protocol stack (DAPS) path switch from a source connection to a target connection, wherein the RRC reconfiguration message indicates an ID of a target relay node; and start a timer for path switch in response to receiving the RRC reconfiguration message.

Some embodiments of the present disclosure provide a base station (BS). The BS may include: a transceiver; and a processor coupled to the transceiver. The processor may be configured to: receive, from a user equipment (UE), capability information associated with a dual active protocol stack (DAPS) path switch; and transmit, to the UE, a radio resource control (RRC) reconfiguration message for the DAPS path switch, wherein the RRC reconfiguration message indicates an ID of a target relay node.

In some embodiments of the present disclosure, the processor may be further configured to receive, from the UE, failure information associated with the DAPS path switch. The failure information may indicate at least one of the following: reception of a notification message from the target relay node; reception of a PC5 unicast link release indication; or detection of an RLF of the sidelink between the UE and the target relay node.

In some embodiments of the present disclosure, the PC5 unicast link release indication may be indicated by an upper layer of the UE or is received from the target relay node at the UE.

In some embodiments of the present disclosure, the notification message may be received in response to one of the following conditions: an RLF between the target relay node and a target cell of the DAPS path switch; a reception of an RRC reconfiguration message including a configuration with synchronization at the target relay node; a cell reselection at the target relay node; an RRC connection establishment failure or an RRC resume failure at the target relay node; a successful handover procedure at the target relay node; a failed handover procedure at the target relay node; an initiation of a reestablishment procedure at the target relay node; a successful reestablishment procedure at the target relay node; a failed reestablishment procedure at the target relay node; and a failed listen-before-talk (LBT) procedure at the target relay node.

In some embodiments of the present disclosure, the capability information may indicate whether the UE supports a DAPS path switch associated with a relay node or not. In some embodiments of the present disclosure, the capability information may indicate at least one of the following: whether the UE supports a path switch from an indirect path to another indirect path or not; or whether the UE supports a path switch from a direct path to an indirect path or not.

Some embodiments of the present disclosure provide a method performed by a user equipment (UE). The method may include: receiving, from a base station (BS), a radio resource control (RRC) reconfiguration message for a dual active protocol stack (DAPS) path switch from a source connection to a target connection, wherein the RRC reconfiguration message indicates an ID of a target relay node; and starting a timer for path switch in response to receiving the RRC reconfiguration message.

Some embodiments of the present disclosure provide a method performed by a relay node. The method may include: receiving, from a user equipment (UE), capability information associated with a dual active protocol stack (DAPS) path switch; and transmitting, to the UE, a radio resource control (RRC) reconfiguration message for the DAPS path switch, wherein the RRC reconfiguration message indicates an ID of a target relay node.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a relay based wireless communication system in accordance with some embodiments of the present disclosure;

FIG. 3 illustrates a flow chart of an exemplary notification message procedure in accordance with some embodiments of the present disclosure;

FIG. 4 illustrates a schematic diagram of a wireless communication system in accordance with some embodiments of the present disclosure;

FIGS. 5-8 illustrate flow charts of exemplary procedures of wireless communications in accordance with some embodiments of the present disclosure; and

FIG. 9 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

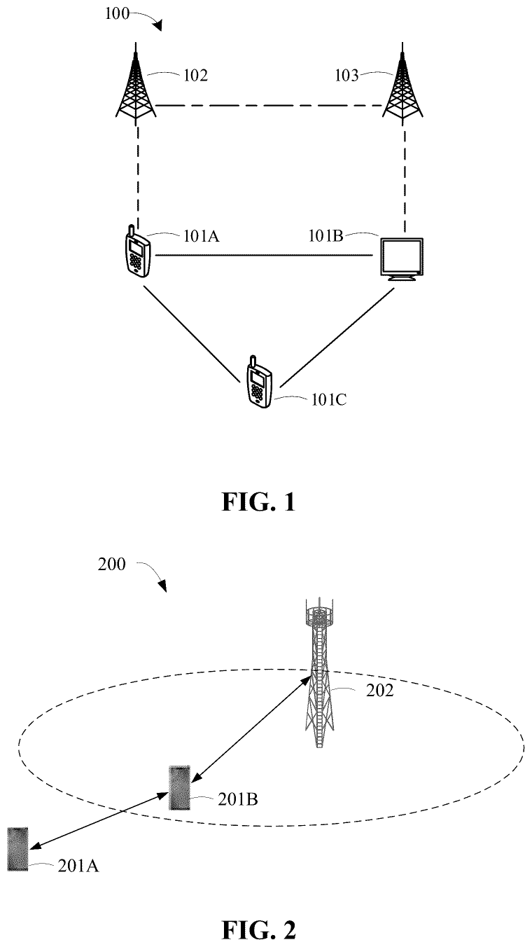

FIG. 1 illustrates a schematic diagram of wireless communication system 100 in accordance with some embodiments of the present disclosure.

As shown in FIG. 1, the wireless communication system 100 may support sidelink communications. Sidelink communication supports UE-to-UE direct communication. In the context of the present disclosure, sidelink communications may be categorized according to the wireless communication technologies adopted. For example, sidelink communication may include NR sidelink communication and V2X sidelink communication.

NR sidelink communications (e.g., specified in 3GPP TS 38 series specification) may refer to access stratum (AS) functionality enabling at least vehicle-to-everything (V2X) communications between neighboring UEs, using NR technology but not traversing any network node. V2X sidelink communications (e.g., specified in 3GPP TS 36 series specification) may refer to AS functionality enabling V2X communications between neighboring UEs, using evolved-universal mobile telecommunication system (UMTS) terrestrial radio access (UTRA) (E-UTRA) technology, but not traversing any network node. However, if not being specified, “sidelink communications” may refer to NR sidelink communications, V2X sidelink communications, or any sidelink communications adopting other wireless communication technologies.

Referring to FIG. 1, wireless communication system 100 may include some base stations (e.g., BS 102 and BS 103) and some UEs (e.g., UE 101A, UE 101B, and UE 101C). Although a specific number of UEs and BSs is depicted in FIG. 1, it is contemplated that any number of UEs and BSs may be included in the wireless communication system 100.

The UEs and the BSs may support communication based on, for example, 3G, long-term evolution (LTE), LTE-advanced (LTE-A), new radio (NR), or other suitable protocol(s). In some embodiments of the present disclosure, a BS (e.g., BS 102 or BS 103) may be referred to as an access point, an access terminal, a base, a base unit, a macro cell, a Node-B, an evolved Node B (eNB), a gNB, an ng-eNB, a Home Node-B, a relay node, or a device, or described using other terminology used in the art. A UE (e.g., UE 101A, UE 101B, or UE 101C) may include, for example, but is not limited to, a computing device, a wearable device, a mobile device, an IoT device, a vehicle, etc. Persons skilled in the art should understand that as technology develops and advances, the terminologies described in the present disclosure may change, but should not affect or limit the principles and spirit of the present disclosure.

In the example of FIG. 1, the BS 102 and the BS 103 may be included in a next generation radio access network (NG-RAN). In some embodiments of the present disclosure, the BS 102 may be a gNB and the BS 103 may be an ng-eNB.

The UE 101A and UE 101B may be in-coverage (e.g., inside the NG-RAN). For example, as shown in FIG. 1, the UE 101A may be within the coverage of BS 102, and the UE 101B may be within the coverage of BS 103. The UE 101C may be out-of-coverage (e.g., outside the coverage of the NG-RAN). For example, as shown in FIG. 1, the UE 101C may be outside the coverage of any BS, for example, both the BS 102 and BS 103. The UE 101A and UE 101B may respectively connect to the BS 102 and BS 103 via a network interface, for example, the Uu interface as specified in 3GPP standard documents. The control plane protocol stack in the Uu interface may include a radio resource control (RRC) layer, which may be referred to as a Uu RRC. The link established between a UE (e.g., UE 101A) and a BS (e.g., BS 102) may be referred to as a Uu link. The BS 102 and BS 103 may be connected to each other via a network interface, for example, the Xn interface as specified in 3GPP standard documents. The UE 101A, UE 101B, and UE 101C may be connected to each other respectively via, for example, a PC5 interface as specified in 3GPP standard documents. The control plane protocol stack in the PC5 interface may include a radio resource control (RRC) layer, which may be referred to as a PC5 RRC. The link established between two UEs (e.g., UE 101A and UE 101B) may be referred to as a PC5 link.

Support for V2X services via the PC5 interface can be provided by, for example, NR sidelink communication and/or V2X sidelink communication. NR sidelink communication can support one of the following three types of transmission modes for a pair of a source Layer-2 identity and a destination Layer-2 identity: unicast transmission, groupcast transmission, and broadcast transmission. Sidelink communication transmission and reception over the PC5 interface are supported when the UE is either in-coverage or out-of-coverage. For example, the UE 101A, which is within the coverage of the BS 102, can perform sidelink transmission and reception (e.g., sidelink unicast transmission, sidelink groupcast transmission, or sidelink broadcast transmission) over a PC5 interface. The UE 101C, which is outside the coverage of both the BS 102 and BS 103, can also perform sidelink transmission and reception over a PC5 interface.

A UE which supports sidelink communication and/or V2X communication may be referred to as a V2X UE. A V2X UE may be a cell phone, a vehicle, a roadmap device, a computer, a laptop, an IoT (internet of things) device or other type of device in accordance with some other embodiments of the present disclosure.

As mentioned above, the relaying function based on a sidelink may be supported in a communication network. A Sidelink relay can provide connectivity to the network for another UE (remote UE). In some embodiments of the present disclosure, a UE-to-network relay is supported. For example, an in-coverage UE in communication with a remote UE (e.g., an out-of-coverage UE or in-coverage UE) may function as a relay UE between the serving BS of the in-coverage UE and the remote UE. The remote UE may thus communicate with the BS via this relay UE. The data between the remote UE and the BS may be transferred by the relay UE. In this scenario, the relay UE may be referred to as a serving relay of the remote UE, and the serving BS or serving cell of the relay UE may be respectively referred to as the serving BS or serving cell of the remote UE.

A remote UE may have RRC states, such as an RRC_IDLE state, an RRC INACTIVE state, and an RRC_CONNECTED state as defined in 3GPP specifications. A relay UE may be in an RRC_CONNECTED state to perform relaying of unicast data. In some embodiments, in a path switch case, a relay UE in an RRC_IDLE, RRC_INACTIVE or RRC_CONNECTED state can be selected as a target relay UE.

In some embodiments, the following RRC state combinations may be supported for a Layer-2 (L2) U2N Relay operation:
Both the relay UE and the remote UE may be in an RRC_CONNECTED state to perform transmission or reception of relayed unicast data; and
The relay UE can be in an RRC_IDLE, RRC_INACTIVE or RRC_CONNECTED state as long as every remote UE that is connected to the relay UE is either in an RRC_INACTIVE state or in an RRC_IDLE state.

A single unicast link may be established between one relay UE and one remote UE. The traffic of the remote UE via a given relay UE and the traffic of the relay UE may be separated in different Uu relay radio link control (RLC) channels. In some embodiments, for the L2 U2N relay, the remote UE may only be configured to use resource allocation mode 2 for data to be relayed.

FIG. 2 illustrates a schematic diagram of relay-based wireless communication system 200 in accordance with some embodiments of the present disclosure. Details described in all of the foregoing embodiments of the present disclosure are applicable for the embodiments shown in FIG. 2.

As shown in FIG. 2, wireless communication system 200 may include a BS (e.g., BS 202) and some UEs (e.g., UE 201A and UE 201B). Although a specific number of UEs and BS is depicted in FIG. 2, it is contemplated that any number of UEs and BSs may be included in the wireless communication system 200. In some examples, UE 201B may function as UE 101A or UE 101B shown in FIG. 1, and UE 201A may function as UE 101C shown in FIG. 1.

UE 201B may be within the coverage of BS 202. For example, UE 201B and BS 202 may establish an RRC connection therebetween. UE 201A may be outside of the coverage of BS 202. The wireless communication system 200 may support sidelink communications. For example, UE 201B may be in sidelink communication with UE 201A. A PC5 RRC connection may be established between UE 201A and UE 201B.

In some embodiments of the present disclosure, UE 201A may initiate a procedure for establishing a connection with BS 202 via UE 201B (i.e., UE-to-network relay). For example, UE 201A may transmit an RRC setup request to BS 202 via UE 201B. BS 202 may transmit an RRC setup message including a response to UE 201A via UE 201B. After such procedure, UE 201A may access BS 202 (e.g., a cell of BS 202) via UE 201B. This cell may be referred to as a serving cell of UE 201A. UE 201A and BS 202 may establish an RRC connection therebetween. UE 201A may also be referred to as a remote UE and UE 201B may also be referred to as a relay UE, a sidelink relay, or a serving relay of UE 201A.

It should be appreciated by persons skilled in the art that although a single relay node (e.g., UE 201B) between UE 201A and BS 202 is depicted in FIG. 2, it is contemplated that any number of relay nodes may be included. Although it is shown in FIG. 2 that UE 201A is outside of the coverage of BS 202, it is contemplated that UE 201A may be within the coverage of BS 202 in some other embodiments of the present disclosure. In these embodiments, UE 201A may directly connect to BS 202 and/or connect to BS 202 via UE 201B.

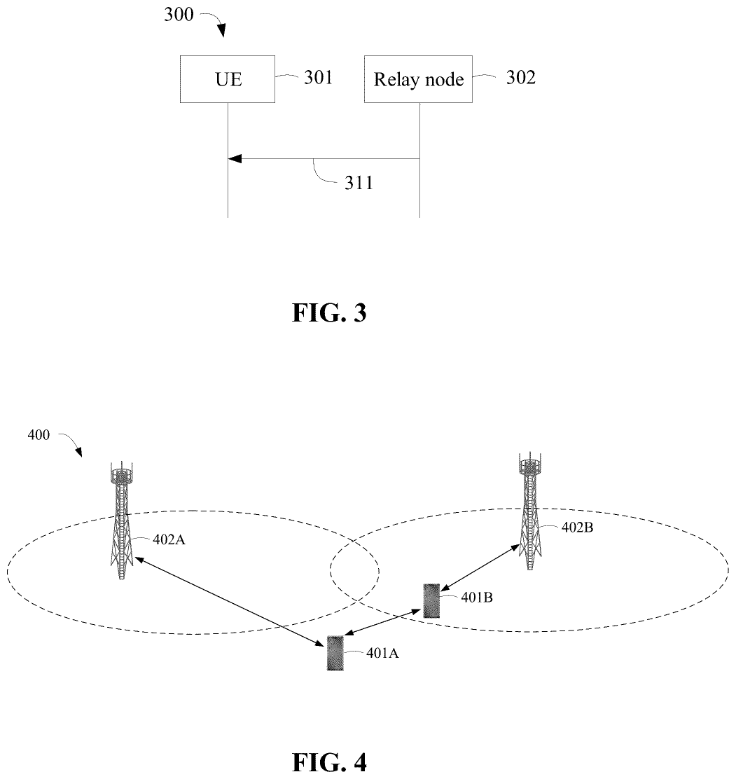

FIG. 3 illustrates a flow chart of exemplary notification message procedure 300 in accordance with some embodiments of the present disclosure. Details described in all of the foregoing embodiments of the present disclosure are applicable for the embodiments shown in FIG. 3.

Referring to FIG. 3, in operation 311, relay node 302 may transmit a notification message to UE 301. In some examples, relay node 302 may be a relay UE such as a U2N relay UE. In this scenario, the notification message may also be referred to as a “notification message for sidelink”.

In some embodiments of the present disclosure, relay node 302 may initiate exemplary procedure 300 when, for example, one of the following conditions is met:
in response to a Uu RLF as will be described below;
in response to the reception of an RRC reconfiguration message including a reconfiguration WithSync information element (IE), such as a handover command;
in response to cell reselection at relay node 302; or
in response to an RRC connection failure at relay node 302, which may include, for example, an RRC connection rejection, an expiry of a timer for an RRC setup request (e.g., T300 as specified in 3GPP specifications), and an RRC resume failure.

The notification message may include a type indication (e.g., “indicationType”), which may indicate that the notification message is due to one of a relay Uu RLF, relay handover, relay cell reselection, and/or relay connection failure.

In some embodiments of the present disclosure, a relay node (e.g., relay node 302) may declare a Uu RLF (e.g., an RLF between the relay node and the BS) based on at least one of the following criteria:
the expiry of a radio problem timer started after the indication of radio problems from the physical layer (if the radio problems are recovered before the timer is expired, the relay node stops the timer); or
the expiry of a timer started upon triggering a measurement report for a measurement identity for which the timer has been configured while another radio problem timer is running; or
a random access procedure failure; or
an RLC failure.

In some embodiments of the present disclosure, a remote UE may be switched (or handed over) from an indirect path (e.g., the UE indirectly accesses a source BS (or source cell) via a source relay node) to another indirect path (e.g., the UE indirectly accesses a target BS (or target cell) via a target relay node). In some embodiments of the present disclosure, a remote UE may be switched (or handed over) from a direct path (e.g., the UE directly accesses a target BS (or target cell) without any relay node) to an indirect path (e.g., the UE indirectly accesses a target BS (or target cell) via a target relay node).

In some embodiments of the present disclosure, during the path switch (or handover), the UE may release the connection with the source cell (e.g., source BS) before the connection is established with the target cell (e.g., target BS). This may also be referred to as “hard handover”. As a result, the data transmission is stopped at the source cell before the UE starts to communicate with the target cell. This would cause an interruption which may be critical for services that are sensitive to latency or continuity.

To overcome the above problem, a DAPS path switch (or DAPS handover) is introduced wherein a UE maintains the source cell (or source BS) connection after the reception of a handover command associated with DAPS, and only releases the source cell connection after a successful access to the target cell (or target BS). This may also be referred to as “soft handover”. In the case of a DAPS handover, a UE may continue to receive DL user data from the source until releasing the source cell and continue to transmit the UL user data transmission to the source BS until a successful random access procedure to the target BS. The DAPS handover thus can be used to reduce or avoid the service interruption and to guarantee service continuity during the handover. This may require a UE to simultaneously receive and transmit data at both the source cell and target cell for a short period during the handover procedure. In the context of the present disclosure, “handover” and “path switch” may be used interchangeably.

FIG. 4 illustrates a schematic diagram of wireless communication system 400 in accordance with some embodiments of the present disclosure. Details described in all of the foregoing embodiments of the present disclosure are applicable for the embodiments shown in FIG. 4.

Referring to FIG. 4, wireless communication system 400 may include some base stations (e.g., BS 402A and BS 402B) and some UEs (e.g., UE 401A and UE 401B). Although a specific number of UEs and BSs is depicted in FIG. 4, it is contemplated that any number of UEs and BSs may be included in the wireless communication system 400. In some examples, UE 401A may function as UE 201A shown in FIG. 2, UE 401B may function as UE 201B shown in FIG. 2, and BS 402A and BS 402B may function as BS 202 shown in FIG. 2.

UE 401A may communicate with BS 402A. In some examples, UE 401A may communicate with BS 402A via a relay node (e.g., a relay UE, not shown in FIG. 4). In some examples, UE 401A may directly communicate with BS 402A without any relay node.

BS 402A may decide to hand over UE 401A to a target relay node (e.g., UE 401B). UE 401B may communications with BS 402B. As shown in FIG. 4, a DAPS handover may be performed. During the DAPS handover, UE 401A simultaneously maintain the source connection and target connection for a certain period.

It should be appreciated by persons skilled in the art that although some of the embodiments in the present disclosure (e.g., FIGS. 2 and 4) are described with respect to a relay UE, it is contemplated that other types of relay nodes may be employed in place of the relay UE.

Various issues need to be solved during a DAPS handover of a remote UE. For example, solutions for handling the target relay node during the DAPS handover of the remote UE are needed. For example, during the DAPS handover, the remote UE may receive various messages from the target relay node. Solutions for handling these messages are needed. For example, solutions for handling an RLF between the remote UE and target relay node during the DAPS handover are needed. For example, solutions for handling the UL transmission are needed. More details on the embodiments of the present disclosure will be illustrated in the following text in combination with the appended drawings.

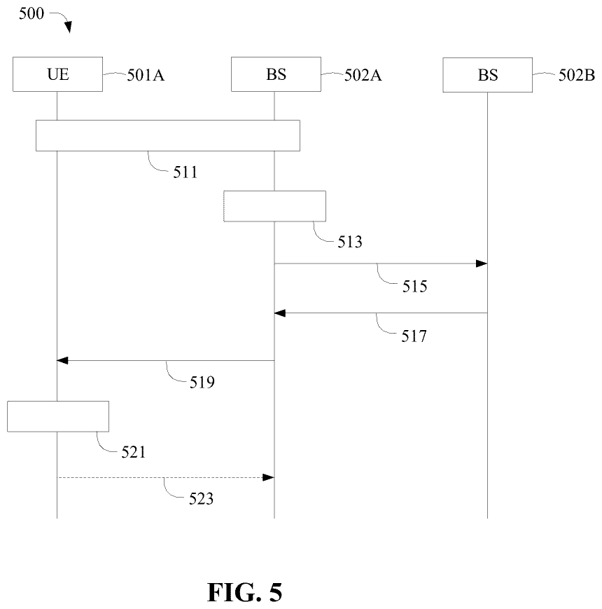

FIG. 5 illustrates a flow chart of exemplary procedure 500 for wireless communications in accordance with some embodiments of the present disclosure. Details described in all of the foregoing embodiments of the present disclosure are applicable for the embodiments shown in FIG. 5.

Referring to FIG. 5, in operation 511, UE 501A may communicate with BS 502A. In some examples, UE 501A may communicate with BS 502A via a relay node (not shown in FIG. 5). The relay node may be a UE (e.g., an L2 U2N relay UE). The remote UE may be in a connected state (e.g., RRC_CONNECTED state). In some examples, UE 501A may directly communicate with BS 502A without any relay node.

In some examples, UE 501A may function as UE 401A shown in FIG. 4, and BS 502A and BS 502B may function as BS 402A and BS 402B shown in FIG. 4.

In some embodiments, UE 501A may report a measurement result to BS 502A based on the configuration from BS 502A. The measurement result may include a measurement result for a cell or a candidate relay node (e.g., relay UE).

In some embodiments, UE 501A may report capability information to BS 502A. In some embodiments, the capability information may be associated with a DAPS path switch. For example, the capability information may indicate whether UE 501A supports a DAPS path switch associated with a relay node (e.g., relay UE) or not. The path switch could be from an indirect path to another indirect path or from a direct path to an indirect path. For example, the capability information may indicate at least one of the following: whether UE 501A supports a path switch from an indirect path to another indirect path or not; or whether UE 501A supports a path switch from a direct path to an indirect path or not.

In operation 513, BS 502A (source BS) may determine to switch UE 501A to a target relay node (e.g., to an indirect path) via a DAPS path switch. In some embodiments, the target relay node may be a relay UE. In operation 515, BS 502A may transmit a handover request message to the target BS (e.g., BS 502B). In some embodiments, the handover request message may include information about UE 501A (e.g., the UE context and a UE ID).

In response to receiving the handover request message, BS 502B may admit the path switch, and may, in operation 517, transmit a handover request acknowledge message to BS 502A via, for example, an Xn interface. The handover request acknowledge message may include an RRC reconfiguration message. The RRC reconfiguration message (may also be referred to as RRC reconfiguration message for path switch) may include an ID of a target relay node (not shown in FIG. 5).

In response to receiving the handover request acknowledge message, BS 502A may transmit an RRC reconfiguration message including a (re)configuration with synchronization to UE 501A in operation 519. In the case of a DAPS path switch, the RRC reconfiguration message may also be referred to as an “RRC reconfiguration message for a DAPS path switch.”

In response to receiving the RRC reconfiguration message, UE 501A may perform a path switch procedure. For example, in operation 521, UE 501A may start a timer for path switch in response to receiving the RRC reconfiguration message. The timer may be T304 as specified in 3GPP specifications in the case of switching to a target cell (e.g., a direct path) or T420 as specified in 3GPP specifications for switching to a target relay (e.g., an indirect path). For example, UE 501A may establish a PC5 connection with the target relay node.

In some embodiments of the present disclosure, UE 501A may indicate the ID of the target cell to the target relay node. This would be advantageous because it can avoid cell reselection at the target relay node.

In some embodiments of the present disclosure, UE 501A may receive a notification message from the target relay node when the timer for path switch (e.g., T420 as specified in 3GPP specifications) is running. In some embodiments, the target relay node may transmit the notification message in response to one of the following conditions: an RLF occurs between the target relay node and the target cell of the DAPS path switch (or between the target relay node and BS 502A); the target relay node receives an RRC reconfigure message including a reconfiguration with synchronization (e.g., a handover command); the target relay node (re)selects a cell; an RRC connection establishment failure or an RRC resume failure occurs at the target relay node; the target relay node successfully performs a handover procedure; a handover fails at the target relay node; the target relay node initiates a reestablishment procedure; the target relay node performs a successful reestablishment procedure; a reestablishment procedure fails at the target relay node; or a listen-before-talk (LBT) procedure fails at the target relay node. The RRC connection establishment failure may include, for example, an RRC connection rejection or the expiry of a timer for RRC setup request (e.g., T300 as specified in 3GPP specifications).

In some embodiments of the present disclosure, in response to receiving the notification message when the timer for path switch is running, UE 501A may revert to the source connection (e.g., the connection to BS 502A) in the case that the source connection is available. In some embodiments of the present disclosure, in response to receiving the notification message when the timer for path switch is running, UE 501A may perform a reestablishment procedure in the case that the source connection is not available.

In some embodiments of the present disclosure, in response to receiving the notification message when the timer for path switch is running, UE 501A may wait for the recovery of the target relay node and may not fall back to the source connection. During the process, UE 501A may transmit or receive data via the source connection.

For example, in response to receiving the notification message when the timer for path switch is running, UE 501A may suspend the target connection (e.g., the connection to BS 502B). For example, in response to receiving the notification message when the timer for path switch is running, UE 501A may suspend the DAPS path switch.

In some embodiments, the target relay node may transmit a recovery indication to UE 501A (e.g., via a notification message) when, for example, the target relay node performs a successful connection establishment or recovery. In some examples, in response to receiving the recovery indication, UE 501A may resume the suspended target connection. In some examples, in response to receiving the recovery indication, UE 501A may resume the suspended DAPS path switch.

In some embodiments, a timer (e.g., timer for recovery) may be employed to determine the waiting time. The value of the timer may be configured by a BS, or predefined, for example, in a standard(s). For example, in response to receiving the notification message, UE 501A may start the timer for recovery. In response to receiving a recovery indication from the target relay node, UE 501A may stop the timer for recovery. In some embodiments, in response to the expiry of the timer for recovery, UE 501A may revert to the source connection in the case that the source connection is available. In some embodiments, in response to the expiry of the timer for recovery, UE 501A may perform a reestablishment procedure in the case that the source connection is not available.

In some embodiments of the present disclosure, UE 501A may receive a PC5 unicast link release indication when the timer for path switch is running. In some embodiments of the present disclosure, in response to receiving the PC5 unicast link release indication when the timer for path switch is running, UE 501A may revert to the source connection (e.g., the connection to BS 502A) in the case that the source connection is available. In some embodiments of the present disclosure, in response to receiving the PC5 unicast link release indication when the timer for path switch is running, UE 501A may perform a reestablishment procedure in the case that the source connection is not available.

In some examples, the PC5 unicast link release indication may be from an upper layer (e.g., PC5-S layer) of UE 501A to a lower layer (e.g., AS layer) of UE 501A. In some examples, the PC5 unicast link release indication may be transmitted by the target relay node. For example, an upper layer (e.g., PC5-S layer) of the target relay node may transmit the PC5 unicast link release indication to an upper layer (e.g., PC5-S layer) of UE 501A.

In some embodiments of the present disclosure, UE 501A may detect an RLF of the sidelink between UE 501A and the target relay node when the timer for path switch is running. In some embodiments of the present disclosure, in response to detecting the RLF when the timer for path switch is running, UE 501A may revert to the source connection (e.g., the connection to BS 502A) in the case that the source connection is available. In some embodiments of the present disclosure, in response to detecting the RLF when the timer for path switch is running, UE 501A may perform a reestablishment procedure in the case that the source connection is not available.

In some embodiments as described above, UE 501A may fall back to the source connection, in some cases, for example, in the case that UE 501A receives a notification message or a PC5 unicast link release indication or in the case that UE 501A detects an RLF of the sidelink between UE 501A and the target relay node when the timer for path switch is running. In these cases, in response to reverting to the source connection, UE 501A may transmit failure information associated with the DAPS path switch to the source BS (e.g., BS 502A) in operation 523 (denoted by a dotted arrow as an option). The failure information may indicate the reason why UE 501A reverts to the source connection. For example, the failure information may indicate at least one of the following: reception of a notification message from the target relay node; reception of a PC5 unicast link release indication; or detection of an RLF of the sidelink between UE 501A and the target relay node. The above descriptions regarding the notification message and the PC5 unicast link release indication may also apply here. After falling back to the source connection, UE 501A may communicate with BS 502A via the source connection (e.g., an indirect path or a direct path).

In some embodiments as described above, UE 501A may perform a re-establishment procedure, in some cases, for example, in the case that UE 501A receives a notification message or a PC5 unicast link release indication or in the case that UE 501A detects an RLF of the sidelink between UE 501A and the target relay node, when the timer for path switch is running. In these cases, after a successful reestablishment, UE 501A may transmit a report regarding a failure that occurs during the DAPS to the BS, which can facilitate mobility robustness optimization (MRO) in the network. For example, UE 501A may transmit a radio link failure related report (e.g., an RLF-report) to the BS.

In some embodiments of the present disclosure, UE 501A may receive an RRC release message from BS 502A. The RRC release message may include redirected carrier information which is used to redirect the UE to an NR or an inter-radio access technology (RAT) carrier frequency, by means of, for example, cell selection at the transition to an RRC_IDLE or RRC_INACTIVE state. For example, BS 502A may use NR, and the redirected carrier information may indicate redirection to an LTE network (e.g., evolved universal terrestrial radio access (E-UTRA) network).

In some embodiments, in the case that a core network (CN) type is indicated in the RRC release message, the AS layer of UE 501A may indicate the available CN type(s) and the received CN type to its upper layers after the cell selection, relay selection or relay reselection.

In some embodiments, in the case that the RRC release message includes a suspend configuration, UE 501A may enter an inactive state (e.g., RRC_INACTIVE) and perform cell selection, relay selection or relay reselection.

In some embodiments, in the case that the RRC release message does not include a suspend configuration, UE 501A may enter an idle state (e.g., RRC_IDLE) and perform cell selection, relay selection or relay reselection.

It should be appreciated by persons skilled in the art that the sequence of the operations in exemplary procedure 500 may be changed and that some of the operations in exemplary procedure 500 may be eliminated or modified, without departing from the spirit and scope of the disclosure.

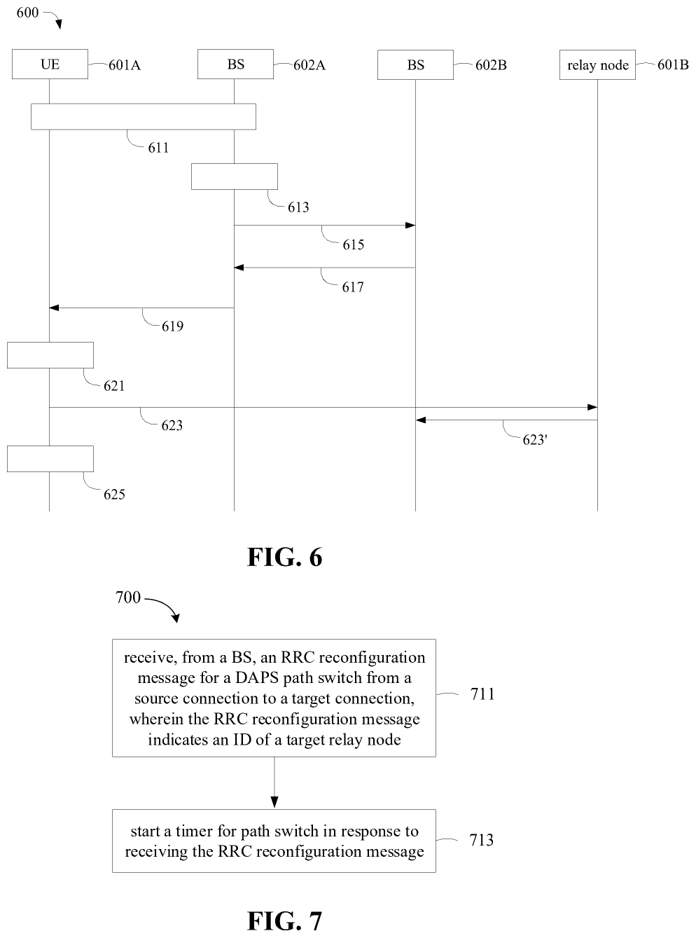

FIG. 6 illustrates a flow chart of exemplary procedure 600 for wireless communications in accordance with some embodiments of the present disclosure. Details described in all of the foregoing embodiments of the present disclosure are applicable for the embodiments shown in FIG. 6.

Referring to FIG. 6, in operation 611, UE 601A may communicate with BS 602A. In some examples, UE 601A may communicate with BS 602A via a relay node (not shown in FIG. 6). The relay node may be a UE (e.g., an L2 U2N relay UE). The remote UE may be in a connected state (e.g., RRC_CONNECTED state). In some examples, UE 601A may directly communicate with BS 602A without any relay node.

In some embodiments, UE 601A may report a measurement result to BS 602A based on the configuration from BS 602A. The measurement result may include a measurement result for a cell or a candidate relay node (e.g., relay UE).

In some embodiments, UE 601A may report capability information to BS 602A. In some embodiments, the capability information may be associated with a DAPS path switch. For example, the capability information may indicate whether UE 601A supports a DAPS path switch associated with a relay node (e.g., relay UE) or not. The path switch could be from an indirect path to another indirect path or from a direct path to an indirect path. For example, the capability information may indicate at least one of the following: whether UE 601A supports a path switch from an indirect path to another indirect path or not; or whether UE 601A supports a path switch from a direct path to an indirect path or not.

In operation 613, BS 602A (source BS) may determine to switch UE 601A to a target relay node (e.g., relay node 601B) via a DAPS path switch. Relay node 601B may connect to BS 602B. In some embodiments, relay node 601B may be a relay UE. In some examples, UE 601A and relay node 601B may function as UE 401A and UE 401B shown in FIG. 4, and BS 602A and BS 602B may function as BS 402A and BS 402B shown in FIG. 4.

In operation 615, BS 602A may transmit a handover request message to the target BS (e.g., BS 602B). In some embodiments, the handover request message may include information about UE 601A (e.g., the UE context and a UE ID).

In response to receiving the handover request message, BS 602B may admit the path switch, and may, in operation 617, transmit a handover request acknowledge message to BS 602A via, for example, an Xn interface. The handover request acknowledge message may include an RRC reconfiguration message. The RRC reconfiguration message (may also be referred to as RRC reconfiguration message for path switch) may include an ID of relay node 601B.

In response to receiving the handover request acknowledge message, BS 602A may transmit an RRC reconfiguration message including a (re)configuration with synchronization to UE 601A in operation 619. In the case of a DAPS path switch, the RRC reconfiguration message may also be referred to as an “RRC reconfiguration message for a DAPS path switch.”

In response to receiving the RRC reconfiguration message, UE 601A may perform a path switch procedure. For example, in operation 621, UE 601A may start a timer for path switch in response to receiving the RRC reconfiguration message. The timer may be T304 as specified in 3GPP specifications in the case of switching to a target cell (e.g., a direct path) or T420 as specified in 3GPP specifications for switching to a target relay (e.g., an indirect path). For example, UE 601A may establish a PC5 connection with relay node 601B.

In some embodiments of the present disclosure, UE 601A may indicate the ID of the target cell to relay node 601B. This would be advantageous because it can avoid cell reselection at relay node 601B.

In operations 623 and 623′, UE 601A may transmit an RRC reconfiguration complete message to BS 602B via relay node 601B. In response to transmitting the RRC reconfiguration complete message, UE 601A may stop the timer for path switch (e.g., T420 as specified in 3GPP specifications) in operation 625.

In some embodiments of the present disclosure, a notification message may be received from relay node 601B after the timer for path switch is stopped (e.g., before the source connection is released). The trigger conditions for a notification message as described above may also apply here.

In some embodiments of the present disclosure, in response to receiving the notification message after the timer for path switch is stopped, UE 601A may perform a reestablishment procedure.

In some embodiments of the present disclosure, in response to receiving the notification message after the timer for path switch is stopped, UE 601A may not perform a reestablishment procedure, especially when the source connection (e.g., the connection to BS 602A) is still available. For example, UE 601A may wait for the recovery of relay node 601B and may not perform a reestablishment procedure. For example, UE 601A may prohibit performing a reestablishment procedure in the case that the source connection is available. In this scenario, since the target connect fails, UE 601A may not receive an RRC reconfiguration message (e.g., for BS 602B) including an indication to release the source connection.

For example, in some embodiments, in response to receiving the notification message after the timer for path switch is stopped, UE 601A may suspend the target connection (e.g., the connection to BS 602B). In some embodiments, relay node 601B may transmit a recovery indication to UE 601A (e.g., via a notification message) when, for example, relay node 601B performs a successful connection establishment or recovery. In some examples, in response to receiving the recovery indication, UE 601A may resume the suspended target connection.

In some embodiments, a timer (e.g., timer for recovery) may be employed to determine the waiting time. The value of the timer may be configured by a BS, or predefined, for example, in a standard(s). For example, in response to receiving the notification message after the timer for path switch is stopped, UE 601A may start the timer for recovery. In response to receiving a recovery indication from relay node 601B, UE 601A may stop the timer for recovery. In some embodiments, in response to the expiry of the timer for recovery, UE 601A may revert to the source connection in the case that the source connection is available. In some embodiments, in response to the expiry of the timer for recovery, UE 601A may perform a reestablishment procedure in the case that the source connection is not available.

In some embodiments of the present disclosure, UE 601A may receive a PC5 unicast link release indication after the timer for path switch is stopped (e.g., before the source connection is released). The descriptions regarding the PC5 unicast link release indication as described above may also apply here. In some embodiments of the present disclosure, in response to receiving the PC5 unicast link release indication after the timer for path switch is stopped, UE 601A may perform a reestablishment procedure.

In some embodiments of the present disclosure, UE 601A may detect an RLF of the sidelink between UE 601A and relay node 601B after the timer for path switch is stopped (e.g., before the source connection is released). In some embodiments of the present disclosure, in response to detecting the RLF after the timer for path switch is stopped, UE 601A may perform a reestablishment procedure.

In some embodiments of the present disclosure, in response to transmitting the RRC reconfiguration complete message (e.g., to BS 602B via relay node 601B in operations 623 and 623′), or stopping the timer for path switch (e.g., in operation 625), UE 601A may perform uplink switching of the DAPS handover. For example, UE 601A may switch the UL transmission to the target connection (e.g., the connection to BS 602B). In some examples, the UL transmission may include a UL packet data convergence protocol (PDCP) data transmission.

In some embodiments of the present disclosure, UE 601A may perform uplink switching of the DAPS handover in response to receiving an indication for uplink switching from relay node 601B.

In some embodiments of the present disclosure, UE 601A may receive an RRC reconfiguration message from BS 602B in response to the RRC reconfiguration complete message. In some embodiments, the RRC reconfiguration message may include an indication to release the source connection. In response to receiving the RRC reconfiguration message, UE 601A may release the source connection (e.g., if the source connection is not released). For example, in the case that the source connection to BS 602A is via a direct path, UE 601A may release the Uu RRC configuration from the source cell (e.g., BS 602A). For example, in the case that the source connection to BS 602A is via an indirect path, UE 601A may release the Uu RRC configuration as well as the PC5 RRC connection between UE 601A and the source relay node.

It should be appreciated by persons skilled in the art that the sequence of the operations in exemplary procedure 600 may be changed and that some of the operations in exemplary procedure 600 may be eliminated or modified, without departing from the spirit and scope of the disclosure.

FIG. 7 illustrates a flow chart of exemplary procedure 700 for wireless communications in accordance with some embodiments of the present disclosure. Details described in all of the foregoing embodiments of the present disclosure are applicable for the embodiments shown in FIG. 7. In some examples, the procedure may be performed by a UE (e.g., a remote UE).

Referring to FIG. 7, in operation 711, a UE may receive, from a BS, an RRC reconfiguration message for a DAPS path switch from a source connection to a target connection, wherein the RRC reconfiguration message indicates an ID of a target relay node. In operation 713, the UE may start a timer for path switch (e.g., T420 as specified in 3GPP specifications) in response to receiving the RRC reconfiguration message.

In some embodiments of the present disclosure, the UE may perform at least one of the following: in response to receiving a notification message from the target relay node when the timer for path switch is running, revert to the source connection in the case that the source connection is available; in response to receiving a PC5 unicast link release indication when the timer for path switch is running, revert to the source connection in the case that the source connection is available; or in response to detecting a radio link failure (RLF) of a sidelink between the UE and the target relay node when the timer for path switch is running, revert to the source connection in the case that the source connection is available.

In some embodiments of the present disclosure, the UE may perform at least one of the following: in response to receiving a notification message from the target relay node when the timer for path switch is running, perform a reestablishment procedure in the case that the source connection is not available; in response to receiving a PC5 unicast link release indication when the timer for path switch is running, perform a reestablishment procedure in the case that the source connection is not available; or in response to detecting a radio link failure (RLF) of a sidelink between the UE and the target relay node when the timer for path switch is running, perform a reestablishment procedure in the case that the source connection is not available.

In some embodiments of the present disclosure, the UE may perform at least one of the following: in response to receiving a notification message from the target relay node when the timer for path switch is running, suspend the target connection; in response to receiving a notification message from the target relay node when the timer for path switch is running, suspend the DAPS path switch; in response to receiving a notification message from the target relay node when the timer for path switch is running, start a timer for recovery; in response to receiving a recovery indication from the target relay node, resume the suspended target connection; in response to receiving a recovery indication from the target relay node, resume the suspended DAPS path switch; in response to receiving a recovery indication from the target relay node, stop the timer for recovery; in response to an expiry of the timer for recovery, revert to the source connection in the case that the source connection is available; or in response to an expiry of the timer for recovery, perform a reestablishment procedure in the case that the source connection is not available.

In some embodiments of the present disclosure, the UE may stop the timer for path switch in response to transmitting an RRC reconfiguration complete message.

In some embodiments of the present disclosure, the UE may perform at least one of the following after stopping the timer for path switch: perform a reestablishment procedure in response to receiving a notification message from the target relay node; perform a reestablishment procedure in response to receiving a PC5 unicast link release indication; in response to detecting a radio link failure (RLF) of a sidelink between the UE and the target relay node, perform a reestablishment procedure; or in response to receiving a notification message from the target relay node, prohibit performing a reestablishment procedure in the case that the source connection is available.

In some embodiments of the present disclosure, the UE may perform at least one of the following after stopping the timer for path switch: in response to receiving a notification message from the target relay node, suspend the target connection; in response to receiving a notification message from the target relay node, start a timer for recovery; in response to receiving a recovery indication from the target relay node, resume the suspended target connection; in response to receiving a recovery indication from the target relay node, stop the timer for recovery; in response to an expiry of the timer for recovery, revert to the source connection in the case that the source connection is available; in response to an expiry of the timer for recovery, perform a reestablishment procedure in the case that the source connection is not available.

In some embodiments of the present disclosure, the UE may, in response to reverting to the source connection, transmit failure information associated with the DAPS path switch to the BS. The failure information may indicate at least one of the following: reception of a notification message from the target relay node; reception of a PC5 unicast link release indication; or detection of an RLF of the sidelink between the UE and the target relay node.

In some embodiments of the present disclosure, the PC5 unicast link release indication may be indicated by an upper layer of the UE. In some embodiments of the present disclosure, the PC5 unicast link release indication may be received from the target relay node.

In some embodiments of the present disclosure, the notification message may be received in response to one of the following conditions: an RLF between the target relay node and a target cell of the DAPS path switch; a reception of an RRC reconfiguration message including a configuration with synchronization at the target relay node; a cell reselection at the target relay node; an RRC connection establishment failure or an RRC resume failure at the target relay node; a successful handover procedure at the target relay node; a failed handover procedure at the target relay node; an initiation of a reestablishment procedure at the target relay node; a successful reestablishment procedure at the target relay node; a failed reestablishment procedure at the target relay node; or a failed LBT procedure at the target relay node.

In some embodiments of the present disclosure, the UE may perform uplink switching in response to one of the following: transmitting an RRC reconfiguration complete message; stopping the timer for path switch; and receiving an indication for uplink switching from the target relay node.

In some embodiments of the present disclosure, the UE may transmit an ID of a target cell of the DAPS path switch to the target relay node.

In some embodiments of the present disclosure, the UE may transmit capability information indicating whether the UE supports a DAPS path switch associated with a relay node or not. The capability information may indicate at least one of the following: whether the UE supports a path switch from an indirect path to another indirect path or not; or whether the UE supports a path switch from a direct path to an indirect path or not.

It should be appreciated by persons skilled in the art that the sequence of the operations in exemplary procedure 700 may be changed and that some of the operations in exemplary procedure 700 may be eliminated or modified, without departing from the spirit and scope of the disclosure.

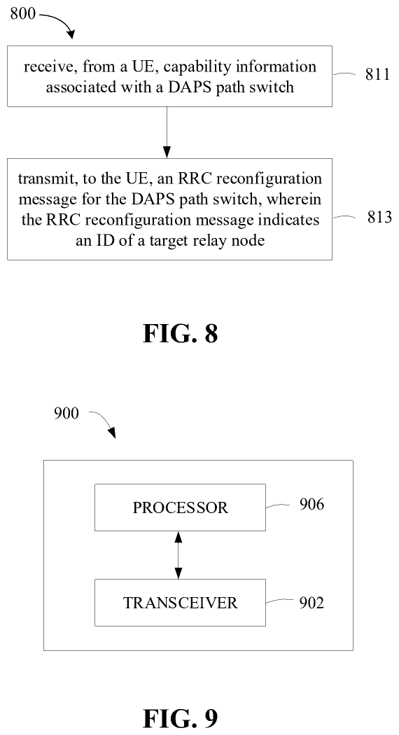

FIG. 8 illustrates a flow chart of exemplary procedure 800 for wireless communications in accordance with some embodiments of the present disclosure. Details described in all of the foregoing embodiments of the present disclosure are applicable for the embodiments shown in FIG. 8. In some examples, the procedure may be performed by a BS.

Referring to FIG. 8, in operation 811, a BS may receive, from a UE, capability information associated with a DAPS path switch. In operation 813, the BS may transmit, to the UE, an RRC reconfiguration message for the DAPS path switch, wherein the RRC reconfiguration message indicates an ID of a target relay node.

In some embodiments of the present disclosure, the BS may receive, from the UE, failure information associated with the DAPS path switch. The failure information may indicate at least one of the following: reception of a notification message from the target relay node; reception of a PC5 unicast link release indication; or detection of an RLF of the sidelink between the UE and the target relay node.

In some embodiments of the present disclosure, the PC5 unicast link release indication may be indicated by an upper layer of the UE. In some embodiments of the present disclosure, the PC5 unicast link release indication may be received from the target relay node at the UE.

In some embodiments of the present disclosure, the notification message may be received in response to one of the following conditions: an RLF between the target relay node and a target cell of the DAPS path switch; a reception of an RRC reconfiguration message including a configuration with synchronization at the target relay node; a cell reselection at the target relay node; an RRC connection establishment failure or an RRC resume failure at the target relay node; a successful handover procedure at the target relay node; a failed handover procedure at the target relay node; an initiation of a reestablishment procedure at the target relay node; a successful reestablishment procedure at the target relay node; a failed reestablishment procedure at the target relay node; or a failed LBT procedure at the target relay node.

In some embodiments of the present disclosure, the capability information may indicate whether the UE supports a DAPS path switch associated with a relay node or not. For example, the capability information may indicate at least one of the following: whether the UE supports a path switch from an indirect path to another indirect path or not; or whether the UE supports a path switch from a direct path to an indirect path or not.

It should be appreciated by persons skilled in the art that the sequence of the operations in exemplary procedure 800 may be changed and that some of the operations in exemplary procedure 800 may be eliminated or modified, without departing from the spirit and scope of the disclosure.

FIG. 9 illustrates a block diagram of exemplary apparatus 900 according to some embodiments of the present disclosure.

As shown in FIG. 9, the apparatus 900 may include at least one processor 906 and at least one transceiver 902 coupled to the processor 906. The apparatus 900 may be a BS, a relay node, or a UE.

Although in this figure, elements such as the at least one transceiver 902 and processor 906 are described in the singular, the plural is contemplated unless a limitation to the singular is explicitly stated. In some embodiments of the present application, the transceiver 902 may be divided into two devices, such as a receiving circuitry and a transmitting circuitry. In some embodiments of the present application, the apparatus 900 may further include an input device, a memory, and/or other components.

In some embodiments of the present application, the apparatus 900 may be a UE. The transceiver 902 and the processor 906 may interact with each other so as to perform the operations with respect to the UEs described in FIGS. 1-8. In some embodiments of the present application, the apparatus 900 may be a relay node. The transceiver 902 and the processor 906 may interact with each other so as to perform the operations with respect to the relay nodes described in FIGS. 1-8. In some embodiments of the present application, the apparatus 900 may be a BS. The transceiver 902 and the processor 906 may interact with each other so as to perform the operations with respect to the BSs described in FIGS. 1-8.

In some embodiments of the present application, the apparatus 900 may further include at least one non-transitory computer-readable medium.

For example, in some embodiments of the present disclosure, the non-transitory computer-readable medium may have stored thereon computer-executable instructions to cause the processor 906 to implement the method with respect to the UEs as described above. For example, the computer-executable instructions, when executed, cause the processor 906 interacting with transceiver 902 to perform the operations with respect to the UEs described in FIGS. 1-8.

In some embodiments of the present disclosure, the non-transitory computer-readable medium may have stored thereon computer-executable instructions to cause the processor 906 to implement the method with respect to the relay nodes as described above. For example, the computer-executable instructions, when executed, cause the processor 906 interacting with transceiver 902 to perform the operations with respect to the relay nodes described in FIGS. 1-8.

In some embodiments of the present disclosure, the non-transitory computer-readable medium may have stored thereon computer-executable instructions to cause the processor 906 to implement the method with respect to the BSs as described above. For example, the computer-executable instructions, when executed, cause the processor 906 interacting with transceiver 902 to perform the operations with respect to the BSs described in FIGS. 1-8.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover” and “path switch” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive, from a base station (BS), a radio resource control (RRC) reconfiguration message for a dual active protocol stack (DAPS) path switch from a source connection to a target connection, wherein the RRC reconfiguration message indicates an identifier (ID) of a target relay node; and
start a timer for the DAPS path switch in response to receiving the RRC reconfiguration message.

2. The UE of claim 1, wherein the at least one processor is further configured to cause the UE to:
in response to receiving a notification message from the target relay node when the timer for the DAPS path switch is running, revert to the source connection when the source connection is available;
in response to receiving a PC5 unicast link release indication when the timer for the DAPS path switch is running, revert to the source connection when the source connection is available; or
in response to detecting a radio link failure (RLF) of a sidelink between the UE and the target relay node when the timer for the DAPS path switch is running, revert to the source connection when the source connection is available.

3. The UE of claim 1, wherein the at least one processor is further configured to cause the UE to:
in response to receiving a notification message from the target relay node when the timer for the DAPS path switch is running, perform a reestablishment procedure when the source connection is not available;
in response to receiving a PC5 unicast link release indication when the timer for the DAPS path switch is running, perform a reestablishment procedure when the source connection is not available; or
in response to detecting a radio link failure (RLF) of a sidelink between the UE and the target relay node when the timer for the DAPS path switch is running, perform a reestablishment procedure when the source connection is not available.

4. The UE of claim 1, wherein the at least one processor is further configured to cause the UE to:
in response to receiving a notification message from the target relay node when the timer for the DAPS path switch is running, suspend the target connection;
in response to receiving a notification message from the target relay node when the timer for the DAPS path switch is running, suspend the DAPS path switch;
in response to receiving a notification message from the target relay node when the timer for the DAPS path switch is running, start a timer for recovery;
in response to receiving a recovery indication from the target relay node, resume the suspended target connection;
in response to receiving a recovery indication from the target relay node, resume a suspended DAPS path switch;
in response to receiving a recovery indication from the target relay node, stop the timer for recovery;
in response to an expiry of the timer for recovery, revert to the source connection when the source connection is available; or
in response to an expiry of the timer for recovery, perform a reestablishment procedure when the source connection is not available.

5. The UE of claim 1, wherein the at least one processor is further configured to cause the UE to:
stop the timer for the DAPS path switch in response to transmitting an RRC reconfiguration complete message; and
after stopping the timer for the DAPS path switch:
perform a reestablishment procedure in response to receiving a notification message from the target relay node;
perform a reestablishment procedure in response to receiving a PC5 unicast link release indication;
in response to detecting a radio link failure (RLF) of a sidelink between the UE and the target relay node, perform a reestablishment procedure; or
in response to receiving a notification message from the target relay node, prohibit performing a reestablishment procedure when the source connection is available.

6. The UE of claim 1, wherein the at least one processor is further configured to cause the UE to:
stop the timer for the DAPS path switch in response to transmitting an RRC reconfiguration complete message; and
after stopping the timer for the DAPS path switch:
in response to receiving a notification message from the target relay node, suspend the target connection;
in response to receiving a notification message from the target relay node, start a timer for recovery;
in response to receiving a recovery indication from the target relay node, resume the suspended target connection;
in response to receiving a recovery indication from the target relay node, stop the timer for recovery;
in response to an expiry of the timer for recovery, revert to the source connection when the source connection is available;
in response to an expiry of the timer for recovery, perform a reestablishment procedure when the source connection is not available.

7. The UE of claim 6, wherein the at least one processor is further configured to cause the UE to, in response to reverting to the source connection, transmit failure information associated with the DAPS path switch to the BS.

8. The UE of claim 7, wherein the failure information indicates at least one of the following:
reception of a notification message from the target relay node;
reception of a PC5 unicast link release indication; or
detection of an RLF of the sidelink between the UE and the target relay node.

9. The UE of claim 8, wherein the PC5 unicast link release indication is indicated by an upper layer of the UE or is received from the target relay node.

10. The UE of claim 8, wherein the notification message is received in response to:
an RLF between the target relay node and a target cell of the DAPS path switch;
a reception of an RRC reconfiguration message including a configuration with synchronization at the target relay node;
a cell reselection at the target relay node;
an RRC connection establishment failure or an RRC resume failure at the target relay node;
a successful handover procedure at the target relay node;
a failed handover procedure at the target relay node;
an initiation of a reestablishment procedure at the target relay node;
a successful reestablishment procedure at the target relay node;
a failed reestablishment procedure at the target relay node; or
a failed listen-before-talk (LBT) procedure at the target relay node.

11. The UE of claim 1, wherein the at least one processor is further configured to cause the UE to perform uplink switching in response to:
transmitting an RRC reconfiguration complete message;
stopping the timer for the DAPS path switch; or
receiving an indication for uplink switching from the target relay node.

12. The UE of claim 1, wherein the at least one processor is further configured to cause the UE to transmit an identifier (ID) of a target cell of the DAPS path switch to the target relay node.

13. The UE of claim 1, wherein the at least one processor is further configured to cause the UE to transmit capability information indicating whether the UE supports a DAPS path switch associated with a relay node.

14. The UE of claim 13, wherein the capability information indicates:
whether the UE supports a path switch from an indirect path to another indirect path; or
whether the UE supports a path switch from a direct path to an indirect path.

15. A base station (BS) for wireless communication, comprising:
at least one memory; and
at least one processor coupled with the at least one memory and configured to cause the BS to:
receive, from a user equipment (UE), capability information associated with a dual active protocol stack (DAPS) path switch; and
transmit, to the UE, a radio resource control (RRC) reconfiguration message for the DAPS path switch, wherein the RRC reconfiguration message indicates an identifier (ID) of a target relay node.

16. The BS of claim 15, wherein the at least one processor is further configured to cause the BS to receive, from the UE, failure information associated with the DAPS path switch, and wherein the failure information indicates at least one of the following:
reception of a notification message from the target relay node;
reception of a PC5 unicast link release indication; or
detection of a radio link failure (RLF) of a sidelink between the UE and the target relay node.

17. The BS of claim 16, wherein the PC5 unicast link release indication is indicated by an upper layer of the UE or is received from the target relay node at the UE.

18. The BS of claim 16, wherein the notification message is received in response to:
an RLF between the target relay node and a target cell of the DAPS path switch;
a reception of an RRC reconfiguration message including a configuration with synchronization at the target relay node;
a cell reselection at the target relay node;
an RRC connection establishment failure or an RRC resume failure at the target relay node;
a successful handover procedure at the target relay node;
a failed handover procedure at the target relay node;
an initiation of a reestablishment procedure at the target relay node;
a successful reestablishment procedure at the target relay node;
a failed reestablishment procedure at the target relay node; and
a failed listen-before-talk (LBT) procedure at the target relay node.

19. A method performed by a base station (BS), the method comprising:
receiving, from a user equipment (UE), capability information associated with a dual active protocol stack (DAPS) path switch; and
transmitting, to the UE, a radio resource control (RRC) reconfiguration message for the DAPS path switch, wherein the RRC reconfiguration message indicates an identifier (ID) of a target relay node.

20. A processor wireless communication, comprising:
at least one controller coupled with the at least one memory and configured to cause the processor to:
receive, from a base station (BS), a radio resource control (RRC) reconfiguration message for a dual active protocol stack (DAPS) path switch from a source connection to a target connection, wherein the RRC reconfiguration message indicates an identifier (ID) of a target relay node; and
start a timer for the DAPS path switch in response to receiving the RRC reconfiguration message.
